(19) United States
(12) Patent Application Publication
(10) Pub. No.: US 2019/0007971 A1
(43) Pub. Date: Jan. 3, 2019

(54) TERMINAL DEVICE, COMMUNICATION METHOD, AND INTEGRATED CIRCUIT

(71) Applicant: SHARP KABUSHIKI KAISHA, Sakai City, Osaka (JP)

(72) Inventors: TOMOKI YOSHIMURA, Sakai City (JP); HIROMICHI TOMEBA, Sakai City (JP); YASUHIRO HAMAGUCHI, Sakai City (JP)

(73) Assignee: SHARP KABUSHIKI KAISHA, Sakai City, Osaka (JP)

(21) Appl. No.: 15/752,381

(22) PCT Filed: Aug. 18, 2016
(86) PCT No.: PCT/JP2016/074098

§ 371 Date: Feb. 13, 2018

(30) Foreign Application Priority Data
Aug. 19, 2015 (JP) 2015-161561

(51) Int. Cl. H04W 74/08; H04L 27/26; H04W 28/06

(52) U.S. Cl. CPC H04W 74/0816; H04W 84/12; H04W 28/06; H04L 27/2626

(57) ABSTRACT

A terminal device decreases degradation of communication performance that is caused by interference and increases in the case that a CCA level is increased. The terminal device communicating with a base station apparatus includes a transmitting unit that transmits a frame, a transmission burst length setting unit that modifies a transmission burst length of the frame, and a carrier sense unit that performs carrier sensing before the frame is transmitted. The transmission burst length is different depending on whether a threshold value for the carrier sensing is configured to a first value or a second value.

### TECHNICAL FIELD

The present invention relates to a terminal device, a communication method, and an integrated circuit.

### BACKGROUND ART

The Institute of Electrical and Electronics Engineering Inc. (IEEE) has formulated IEEE802.11ac that is intended to achieve a high-speed version of IEEE802.11 that serves as a wireless local area network (LAN) standard. An activity to standardize IEEE802.11ax as a succeeding standard to IEEE802.11ac has been now started. Along with the widespread use of wireless LAN devices, a study is being made in the standardization of IEEE802.11ax to increase the throughput of the wireless LAN devices per user in an overcrowded environment of the wireless LAN devices.

A wireless LAN system performs a possibility determination, based on carrier sensing (CS). If the carrier sensing determines that a reception interference level is lower than a threshold value, transmission is determined to be possible. If interference power higher than the threshold value is received, the transmission is avoided.

In the standardization of IEEE802.11ax, the modification or dynamic control of a carrier sensing threshold value is being discussed. In the overcrowded environment of wireless LAN devices, an increase in the carrier sensing threshold value is likely to improve transmission opportunity in each device. However, there is a concern that an increase in the carrier sensing threshold value increases the interference level on a receiver side.

Non-Patent Literature 1 discloses a method of interference control. According to Non-Patent Literature 1, interference is controlled by dynamically varying threshold values for the carrier sensing (a threshold value for the carrier sensing, a carrier sensing level, and a clear channel assessment (CCA) level). This is a mechanism that the transmission opportunity is increased by increasing the CCA level if terminal devices have mutually a shorter distance therebetween. If the CCA level is increased, an increase in an amount of interference to another terminal device is also likely.

### CITATION LIST

### Non Patent Literature

NPL 1: IEEE 802.11-14/0779r2 DSC Practical Usage

### SUMMARY OF INVENTION

### Technical Problem

The object of the present invention is to solve the problem of degradation of communication performance that increases due to interference in the case that a terminal device increases a CCA level, and to increase frequency usage efficiency.

### Solution to Problem

A terminal device, a communication method, and an integrated circuit related to one embodiment of the present invention to solve the problem are described below.

(1) According to one aspect of the present invention, a terminal device communicating with a base station device includes a transmission burst length setting unit that modifies a transmission burst length of a first frame, and a carrier sense unit that configures a threshold value for the carrier sensing to one of at least two values. The transmission burst length that is configured in the case that the threshold value for the carrier sensing is configured to one of the two threshold values is different in range from the transmission burst length that is configured in the case that the threshold value for the carrier sensing is configured to the other of the two threshold values.

According to another aspect of the present invention, the terminal device in view of the terminal apparatus according to aspect (1), the transmission bust length is related to a number of aggregated first frames.

(3) According to another aspect of the present invention, the terminal device in view of the terminal device according to aspect (1), the transmission burst length is related to a transmission time needed to transmit the first frame.

(4) According to another aspect of the present invention, the terminal device in view of the terminal device according to one of the aspects (1) through (3) includes a receiving unit that receives a second frame including information to be used to configure a range of the transmission burst length.

(5) according to another aspect of the present invention, a communication method of a terminal apparatus communicating with a base station includes a step of modifying a transmission burst length of a first frame, and configuring a threshold value for the carrier sensing to one of at least two values. The transmission burst length that is configured in the case that the threshold value for the carrier sensing is configured to one of the two threshold values is different in range from the transmission burst length that is configured in the case that the threshold value for the carrier sensing is configured to the other of the two threshold values.

(6) According to another aspect of the present invention, an integrated circuit is mounted on a terminal device that communicates with a base station, and causes the terminal device to perform multiple functionalities. The integrated circuit has a functionality to modify the transmission burst length of the first frame, and a functionality to configure a threshold value for the carrier sensing to at least two values. The transmission burst length that is configured in the case that the threshold value for the carrier sensing is configured to one of the two threshold values is different in range from the transmission burst length that is configured in the case that the threshold value for the carrier sensing is configured to the other of the two threshold values.

### Advantageous Effects of Invention

According to the present invention, the problem of degradation of communication performance caused by interference that increases in the case that the terminal device increases the CCA level is solved, and frequency usage efficiency is increased. An improved terminal device, communication method, and integrated circuit are provided.

### BRIEF DESCRIPTION OF DRAWINGS

FIG. 1 illustrates an example of a management area of a radio communication system of an embodiment.

FIG. 2 illustrates an example of an apparatus configuration of a base station apparatus of the embodiment of the present invention.

FIG. 3 illustrates an example of a process of the terminal device of the embodiment of the present invention.

FIG. 4 illustrates an example of a table illustrating a relationship between an A-MPDU maximum aggregation number and CCA level in accordance with the embodiment of the present invention.

FIG. 5 is a flowchart illustrating an example of process performed by the base station apparatus and the terminal device in accordance with the embodiment of the present invention.

### DESCRIPTION OF EMBODIMENTS

A communication system of an embodiment includes a radio transmission apparatus (access point or base station apparatus), and multiple radio receiving apparatuses (station or terminal device). A network including the base station apparatus and multiple terminal devices is referred to as a basic service set (BSS) The base station apparatus, and the terminal devices are collectively referred to as radio apparatuses.

The base station apparatus and the terminal devices in the BSS performs communications in accordance with carrier sense multiple access with collision avoidance (CSMA/CA). The embodiment is related to an infrastructure mode in which the base station apparatus communicates with multiple terminal devices. The method of the embodiment may be embodied in an ad hoc mode in which terminal devices directly communicate with each other. In the ad hoc mode, the BSS in which a terminal device is substituted for the base station apparatus is formed. The BSS in the ad hoc mode is also referred to as independent basic service set (IBSS). In the following discussion, a terminal device forming the IBSS in the ad hoc mode is referred to as the base station apparatus.

In an IEEE802.11 system, each device may transmit multiple frame types of transmission frames having a common frame format. The transmission frame is defined by each of a physical (PHY) layer, a medium access control (MAC) layer, and a logical link control (LLC) layer.

The transmission frame of the PHY layer is referred to as a PHY protocol data unit (PPDU, a physical layer frame). PPDU includes a physical layer header (PHY header) including header information used to perform signal processing in the physical layer, and PHY physical service data unit (PSDU, MAC layer frame) as a data unit processed in the physical layer, and the like. PSDU includes an aggregated MPDU (A-MPDU) which includes multiple MAC protocol data units (MPDUs), each serving as a retransmission unit in a wireless section.

The PHY header includes reference signals, such as a short training field (STF) used to detect and synchronize signals, and a long training field (LTF) to be used to acquire channel information for data demodulation, and control signals, such as a signal (SIG) including control information for data demodulation. Depending on applied standard, STFs may be classified into legacy STF (L-STF), high throughput STF (HT-STF), very high throughput STF (VHT-STF). Similarly, LTFs and SIGs are classified into L-LTF, HT-LTF, VHT-LTF, L-SIG, HT-SIG, and VHT-SIG. VHT-SIGs are further classified into VHT-SIG-A and VHT-SIG-B.

The PHY header may also include information that identifies BSS of a transmission source of the transmission frame (hereinafter referred to as BSS identification information). The information identifying BSS may be a service set identifier (SSID) of the BSS or a MAC address of the base station apparatus of the BSS. The information identifying the BSS may be a value unique to the BSS (such as BSS color) in addition to SSID or MAC address.

The PPDU is modulated in accordance with the standard that is applicable. For example, in the case of IEEE802.11n standard, the PPDU is modulated into a orthogonal frequency division multiplexing (OFDM) signal.

The MPDU includes a MAC layer header (MAC header) including header information and the like for performing signal processing in the MAC layer, a MAC service data unit (MSDU) that is a data unit to be processed in the MAC layer, or a frame body, and a frame check sequence (FCS) that checks whether there is an error in a frame. Multiple MSDUs may be aggregated as an aggregated MSDU (A-MSDU).

The frame types of the transmission frames in the MAC layer are classified into three main types of data frames including a management frame managing a connection state between devices or the like, a control frame managing a communication state between devices, and a data frame including actual transmission data. Each frame is further classified into multiple types of sub frames. The control frames include an acknowledge (Ack) frame, a request to send (RTS) frame, a clear to send (CTS) frame and the like. The management frames include a beacon frame, a probe request frame, a probe response frame, an authentication frame, an association request frame, an association response frame, and the like. The data frames include a data frame, a polling (CF-poll) frame, and the like. By reading contents of a frame control field included in the MAC header, each device learns the frame type and the sub frame type of a received frame.

Ack may include Block Ack. Block Ack may acknowledge the reception of multiple MPDUs.

The beacon frame includes a field where a beacon transmission interval and the SSID are written. The base station apparatus is able to periodically report the beam frame to within the BSS, and the terminal device is able to recognize the base station apparatus around the terminal device by receiving the beacon frame. The operation that the terminal device recognizes the base station apparatus in accordance with the beacon frame reported by the base station apparatus is referred to passive scanning. On the other hand, the operation that the terminal device searches for the base station apparatus by reporting the probe request frame to within the BSS is referred to active scanning. The base station apparatus is able to transmit the probe response frame in response to the probe request frame, and the written contents of the probe response frame are identical to the beam frame.

After recognizing the base station apparatus, the terminal device performs an association process to the base station apparatus. The association process includes an authentication procedure and an association procedure. The terminal device transmits an authentication frame (authentication request) to the base station apparatus to which the terminal device desires to connect. Upon receiving the authentication frame, the base station apparatus transmits to the terminal device an authentication frame (authentication response) including a status code indicating authentication grant/denial. By reading the status code written on the authentication frame, the terminal device may determine whether the base station apparatus has granted authentication to the terminal device. Authentication frames may be exchanged between the base station apparatus and the terminal device by multiple times.

In succession to the authentication procedure, the terminal device transmits an association request frame to the base station apparatus to perform, the association procedure. Upon receiving the association request frame, the base station apparatus determines whether to permit the terminal device to be connected thereto, and transmits an association response frame to the terminal device to notify the terminal device of determination results. The association response frame includes an association identifier (AID) identifying the terminal device, in addition to a status code indicating grant/denial to the association process. By configuring different AIDs to the terminal devices to which association is granted, the base station apparatus is able to manage multiple terminal devices.

Subsequent to the association process, data is actually exchanged between the base station apparatus and the terminal device. Defined in the IEEE802.11 system are distributed coordination function (DCF) and point coordination function (PCF), and extended versions of these functions (enhanced distributed channel access (EDCA)), and hybrid coordination function (HCF), and the like. In the following discussion, the base station apparatus transmits signal in the DCF to the terminal device.

In the DCF, prior to communications, the base station apparatus and the terminal device perform carrier sense (CS) to check the usage status of radio channels around those apparatuses. For example, if the base station apparatus serving as a transmitting station receives a signal of a level higher than a predetermined clear channel assessment level (CCA level) on the radio channel, the base station apparatus postpones the transmission of a transmission frame on the radio channel. In the following discussion, a state in which a signal of level equal to or higher than the CCA level is detected on the radio channel is referred to as a busy state, and a state in which a signal of level equal to or higher than the CCA level is not detected on the radio channel is referred to as an idle state. The CS that each device performs depending on the power of an actually received signal is referred to as a physical carrier sense (physical CS). The CCA level is also referred to as a carrier sense level (CS level) or a CCA threshold (CCAT). If a signal of level equal to or higher than the CCA level is detected, the base station apparatus and the terminal device start demodulating the signal at least in the PHY layer.

The base station apparatus performs the carrier sense during an inter frame space (IFS) responsive to the type of a transmission frame to be transmitted, and determines whether the radio channel is in the busy state or the idle state. The period throughout which the base station apparatus performs the carrier sense is different depending on the frame type and sub frame type of the transmission frame that the base station apparatus has transmitted. Multiple IFSs different in the period are defined in the IEEE802.11 system, and include a short frame inter frame space (SIFS or short IFS) used in the transmission frame having the highest priority, a polling inter frame space (PCF IFS or PIFS) used in the transmission frame having a relatively higher priority, and a distributed control frame inter frame space (DCF IFS or DIFS) used in the transmission frame having the lowest priority, and the like. To transmit a data frame in the DCF, the base station apparatus uses the DIFS.

After waiting on standby for the DIFS only, the base station apparatus further waits on standby for a random backoff time to avoid frame collision. The random backoff time called a condition window (CW) is used in the IEEE802.11 system. The CSMA/CA is based on the premise that the transmission frame transmitted by a given transmitting station is received by a receiving state that is free from interference from other transmitting stations. If transmitting stations transmit the transmission frames at the same timing, the frames collide with each other, and the receiving station is unable to normally receive the transmission frames. Prior to the start of transmission, each transmitting station waits on standby for a randomly set time, thereby avoiding frame collision. If the base station apparatus determines through the carrier sense that the radio channel is in the idle state, the base station apparatus starts counting down CW, acquires a transmission right in the case that the CW becomes 0, and is then able to transmit the transmission frame to the terminal device. If the base station apparatus determines through the carrier sense that the radio channel is in the busy state, the base station apparatus stops counting down CW. When the radio channel shifts into the idle state, the base station apparatus starts again counting down the remaining CW in succession to the preceding IFS.

The terminal device serving as a receiving station receives the transmission frame, reads the PHY header of the transmission frame, and demodulates the received transmission frame. By reading the MAC header of the demodulated signal, the terminal device recognizes whether the transmission frame is addressed to the terminal device. Noted that the terminal device is able to determine the destination of the transmission frame, based on information written on the PHY header (such as a stored group identifier (GID) written on the VHT-SIG-A).

If the terminal device serving as a receiving station has determined that the received transmission frame is addressed to the terminal device, and has demodulated the transmission frame in an error free fashion, the terminal device needs to transmit to the base station apparatus an ACK frame indicating that the frame has been normally received. The ACK frame is one of the transmission frames having the highest priority transmitted during the standby of the SIFS period (excluding the random backoff). When the base station apparatus receives the ACK frame transmitted from the terminal device, a series of communications is completed. If the terminal device fails to normally receive the frame, the terminal device does not transmit the ACK frame. If the base station apparatus does not receive the ACK frame from the receiving station during a specific period of time (SIFS+ACK frame length) subsequent to the transmission of the frame, the base station apparatus determines that the communication failed, and ends the communication. The end of one communication (also called a burst) in the IEEE802.11 system has to be determined by referencing the presence or absence of the received ACK frame except when a report signal, such as a beacon beam, is transmitted, or except when fragmentation to fragment transmission data is performed.

If the terminal device determines that the received transmission frame is not addressed to the terminal device, a network allocation vector (NAV) is configured, based on the length of the transmission frame written in the PHY header. The terminal device does not attempt to communicate during a period that is configured in the NAV. In other words, during the period configured in the NAV, the terminal device performs the same operation as the operation that is performed in the case that the physical CS determines that the radio channel is the busy state, and thus communication control performed by the NAV is also called virtual carrier sense (virtual CS). The NAV is configured in accordance with the information written in the PHY header. Note that NAV is also configured by the request to send (RTS) frame that is introduced to clear the problem of hidden terminals, or by a clear to send (CTS) frame.

In contrast with the DCF in which each device performs the carrier sense, and the transmission right is autonomously acquired, while in the PCF a control station called a point coordinator (PC) controls the transmission right of the terminal device in the BSS.

The communication period by the PCF includes a contention free period (CFP) and a contention period (CP). During the CP, communication is performed, based on the DCF described above. A period throughout which PC controls the transmission right is a duration of the CFP. Prior to the communication of the PCF, the base station apparatus as the PC reports to within BSS the beacon frame on which the CFP maximum duration is written PISF is used to transmit the beacon frame that is reported at the start of the transmission of the PCF, and the beacon frame is transmitted without waiting for the CW. The terminal device, having received the beacon frame, configures the duration of the CFP in the NAV. Until the NAV has elapsed or a signal reporting the end of CFP to within BSS (for example, a data frame including CF-end) has been received, the terminal device is able to acquire the transmission right only in the case that a signal (such as a data frame including CF-poll) signaling the acquisition of the transmission right transmitted from the PC is received. Since packet collision does not occur within the same BSS during the period of the CFP, each terminal device does not take the random backoff time to be used in the DCF.

AP and STA are able to store Information related to a maximum aggregation number (maximum A-MPDU length) of receivable A-MPDU in a maximum A-MPDU length exponents sub field. Information written in the maximum A-MPDU length exponents field is an integer value. If the integer value is X, the AP and the STA are able to receive a frame having the A-MPDU having a length of 2̂(13+X)−1 octes. The AP and STA, serving as sender terminal devices, should not transmit to an AP and STA, serving as destination terminal devices, a frame having a A-MPDU having a length longer than the maximum A-MPDU that the AP and STA, serving as the destination terminal devices, are able to receive.

The AP and STA are able to store the receivable maximum aggregation number of A-MSDU (maximum A-MSDU length) in a Max Number of MSDUs In A-MSDU sub field or a maximum A-MSDU length field. The Max Number of MSDUs In the A-MSDU is information indicating the number of MSDUs that are aggregatable. The maximum A-MSDU Length indicates the A-MSDU length receivable. The AP and STA, serving as sender terminal devices, should not transmit to an AP and STA, serving as destination terminal devices, a frame having an A-MSDU having a length longer than the maximum A-MSDU that AP and STA, serving as the destination terminal devices, are able to receive.

In the following discussion, the terminal device may have the same functionality as that of the base station apparatus. The base station apparatus may have the same functionality as that of the terminal device. Unless otherwise particularly noted, the base station apparatus and the terminal device are able to have the same functionality.

### 1. First Embodiment

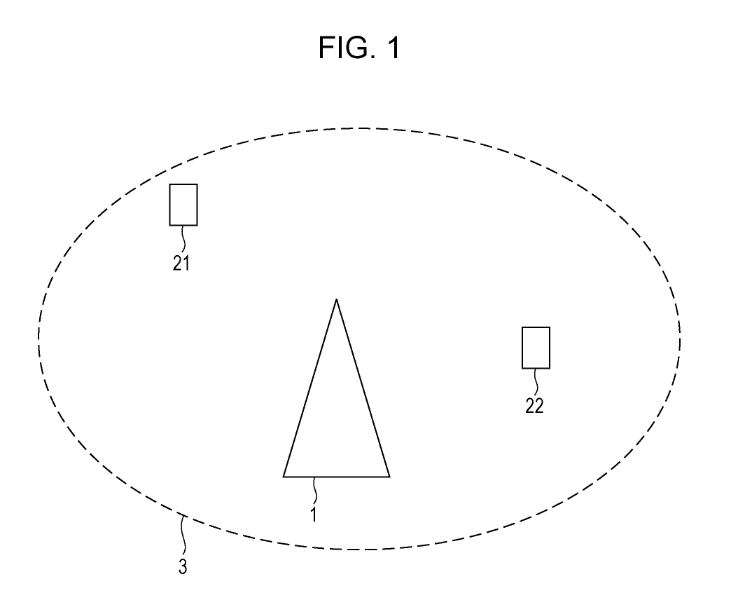

FIG. 1 illustrates a management area 3 of a radio communication system of a first embodiment. The management area 3 includes a base station apparatus 1, a terminal device 21, and a terminal device 22. In the following discussion, the terminal device 21 and the terminal device 22 are collectively referred to as a terminal device 20. In the example of FIG. 1, the management area 3 includes two terminal devices 20. The method of the first embodiment may be embodied if the management area 3 includes one or more terminal devices 20.

Prior to transmitting a transmission frame in radio space, the base station apparatus 1 and the terminal device 20 perform a transmission possibility determination through carrier sense. The base station apparatus 1 and terminal device 20 store information related to the CCA level that is a threshold value for the carrier sense. Information related to the CCA level may be used to configure the CCA level of the base station apparatus 1 and terminal device 20.

Each terminal device 20 may configure a different CCA level. For example, the terminal device 21 may configure CL21 for the CCA level, and the terminal device 22 may configure CL22 for the CCA level. The terminal device 20 may modify CL21 and CL22 as the CCA level in response to time, frequency, destination of the transmission frame, and the type of the transmission frame (characteristics, properties, lengths, and types of information).

The base station apparatus 1 may configure the CCA level CL1. The base station apparatus 1 may dynamically configure the CCA level CL1. For example, the base station apparatus 1 may modify the CCA level CL1 in accordance with time, frequency, the destination of the transmission frame, and the type the transmission frame.

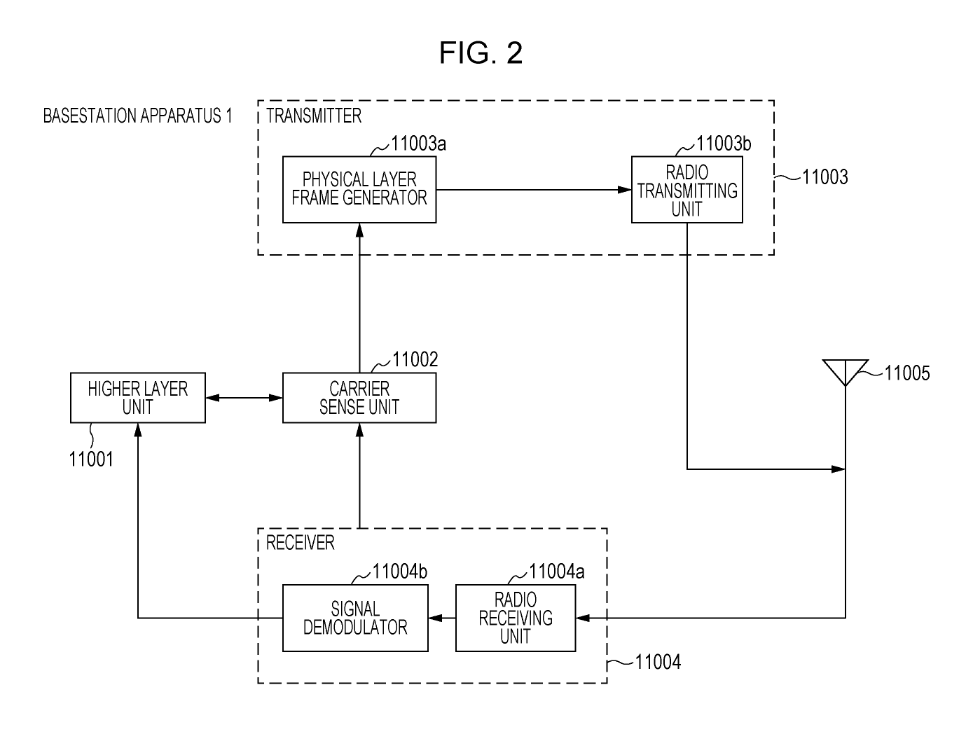

FIG. 2 illustrates an example of an apparatus configuration of the base station apparatus 1. The base station apparatus 1 includes a higher layer unit 11001, a carrier sense unit 11002, a transmitter 11003, a receiver 11004, and an antenna unit 11005.

The higher layer unit 11001 has a functionality to notify the carrier sense unit 11002 connected to another network of information related to a transmission frame. The transmission frame described below is defined in the MAC layer, but may be defined in another layer. For example, the transmission frame may be defined in the LLC layer, or the physical layer. The higher layer unit 11001 includes a transmission burst length setting unit 11006 that configures a transmission burst length. The transmission burst length is described below.

The carrier sense unit 11002 has a functionality to perform a transmission possibility determination in accordance with the carrier sense. The carrier sense unit 11002 may notify the higher layer unit 11001 of information related to the CCA level used in the carrier sense. The information related to the CCA level may be a CCA level value that the carrier sense unit 11002 has used in the carrier sense.

The transmitter 11003 includes a physical layer frame generator 11003a and a radio transmitting unit 11003b.

The physical layer frame generator 11003a has a functionality to generate a physical layer frame from the transmission frame notified by the carrier sense unit 11002. The physical layer frame generator 11003a performs error correction coding, modulation, precoding filter multiplication, or the like on the transmission frame. The physical layer frame generator 11003a notifies the radio transmitting unit 11003b of the generated physical layer frame.

The radio transmitting unit 11003b converts the physical layer frame generated by the physical layer frame generator 11003a into a signal in a radio frequency (RF) band, thereby generating a radio frequency signal (carrier wave signal or the like). The processes to be performed by the radio transmitting unit 11003b include digital-to-analog conversion, filtering, frequency conversion from a baseband to an RF band, and the like.

The receiver 11004 includes a radio receiving unit 11004a, and a signal demodulator 11004b.

The radio receiving unit 11004a has a functionality to convert a signal in the RF band received by the antenna unit 11005 into a baseband signal to generate a physical layer signal (such as a physical layer frame). The process performed by the radio receiving unit 11004a includes a frequency conversion for conversion from the RF band to the baseband band, filtering, and analog-to-digital conversion.

The signal demodulator 11004b has a functionality to demodulate a physical layer signal generated by the radio receiving unit 11004a. The process to be performed by the signal demodulator 11004b includes operations, such as channel equalization, demapping, error correction and demodulation. The signal demodulator 11004b may extract, from the physical layer signal, information included in the physical layer header, information included in the MAC header, and information included in the transmission frame. The signal demodulator 11004b notifies the higher layer unit 11001 of the extracted information. Note that the signal demodulator 11004b may extract one or more pieces of the information included in the physical layer header, the information included in the MAC header, and the information included in the transmission frame.

The antenna unit 11005 has a functionality to transmit a radio frequency signal generated by the radio transmitting unit 11003b into the radio space. The antenna unit 11005 also has a functionality to receive a radio frequency signal. The antenna unit 11005 has a functionality to receive a signal at a corresponding channel present in the radio space in the case that the base station apparatus 1 performs the carrier sense.

The apparatus configuration of the terminal device 20 is not described herein because the terminal device 20 is identical in configuration to the base station apparatus 1 performs the carrier sense.

The following discussion focuses on the feature of the terminal device 20 unless otherwise particularly noted. The base station apparatus 1 has the same feature.

The terminal device 20 has a functionality to define the relationship between the length of the transmission frame (also referred to as a transmission burst length) and the CCA level. For example, the terminal device 20 has a functionality to modify the CCA level, based on the transmission burst length, and to modify the transmission burst length, based on the CCA level. The transmission burst length may be expressed as a period of one or more transmission frames that the antenna unit 11005 transmits in the radio space, or may be expressed as a quantity of information of the transmission frame (such as the number of information bits, A-MPDU, and A-MSDU aggregation number).

In accordance with one aspect of the present invention, the terminal device 20 may perform adequately interference control by associating the transmission burst length with the CCA level. For example, it may be assumed that the transmission burst length of the transmission frame that the terminal device 21 is ready to transmit is 100 μs. It may also be assumed that the terminal device 22 starts to transmit after an average standby time of 105 μs if the terminal device 22 does not detect the transmission frame of the terminal device 21 (for example, if the transmission frame transmitted by the terminal device 21 and received by the terminal device 22 has a reception signal intensity that fails to reach the CCA level of the terminal device 22). In such a case, the terminal device 21 is able to complete the transmission of the transmission frame in a manner free from the effect of an interfering signal from the terminal device 22. On the other hand, since the transmission burst length of the transmission frame at the terminal device 21 is 4000 μs, the terminal device 22 starts to transmit during the transmission of the transmission frame, and the transmission frames collide with each other.

In view of the above example, it is appropriate to associate the CCA level of the terminal device 20 with the transmission burst length of the terminal device 21.

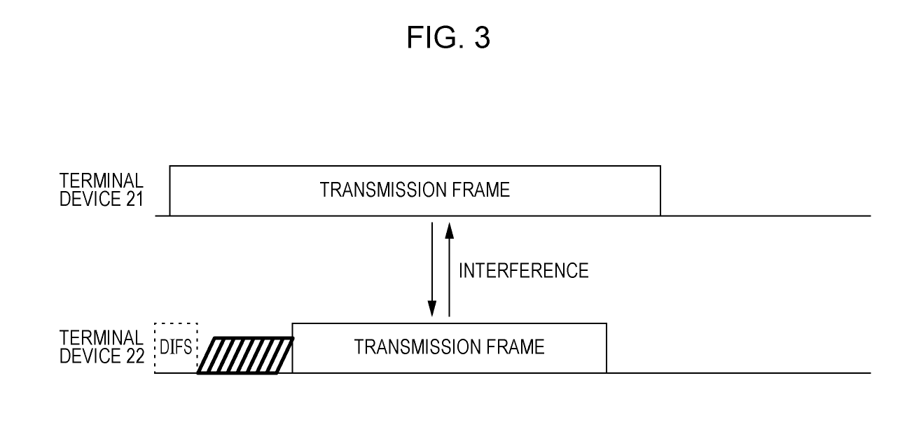

FIG. 3 illustrates an example of a process of the terminal device 20. If the terminal device 21 transmits the transmission frame excessively longer than an average waiting time (or a waiting time, and each of the average waiting time and the waiting time is determined to be a period including the IFS and the backoff time), the terminal device 22 starts transmitting the signal after waiting on standby for a period equal to the IFS (DIFS in the example of FIG. 3) period and the backoff time (each parallelogram illustrated in FIG. 3 represents a slot time forming the backoff time). The transmission frames from both devices thus interfere with each other.

To solve the above problem, it is appropriate to associate information concerning the upper limit of the transmission burst length configured in the management area 3 with the CCA level configured in the management area 3 (or an upper limit value, an average value, a lower limit value, or the like in the CCA level configuration).

For example, the upper limit value in the CCA level configuration is increased if the A-MPDU maximum aggregation number of the management area 3 is smaller, and the upper limit value in the CCA level configuration is decreased if the A-MPDU maximum aggregation number of the management area 3 is larger.

In IEEE802.11, an HT capabilities field including A-MPDU length limit information is defined. The HT capabilities field is one of information regions that the base station apparatus 1 and terminal device 20 are able to include in a beacon, a management frame, or a transmission frame. The A-MPDU length limit information may be used report information concerning the receivable A-MPDU maximum aggregation number. For example, if the base station apparatus 1 transmits, as the A-MPDU length limit information, the transmission frame that includes a receivable A-MPDU maximum aggregation number of 2, the transmission frame configuration of the terminal device 20 that receives the transmission frame is limited to an A-MPDU maximum aggregation number of 2 or less. More specifically, the base station apparatus 1 may configure the information concerning the A-MPDU maximum aggregation number of the management area 3 using the A-MPDU length limit information.

The information concerning the A-MPDU maximum aggregation number configured in the management area 3 is not limited to the information described above. For example, the base station apparatus 1 or terminal device 20 may configure, in the management area 3, information that limits the A-MPDU maximum aggregation number included in one transmission frame (burst length limiting information).

The burst length limiting information is not limited to the information described above. For example, the burst length limiting information includes information limiting the MSDU number, or information that limits a quantity of information included in one transmission frame. The burst length limiting information may be information that limits the transmission burst length. The burst length limiting information may be information concerning the NAV.

A relationship between the transmission burst length and the CCA level is described next based on the assumption that the transmission burst length is expressed by the MPDU aggregation number.

The relationship between the transmission burst length and the CCA level is expressed by equation Coffset=α×Cbase. Coffset is a CCA level difference value (also referred to as a CCA offset) from a reference CCA level value (a CCA level value used in current IEEE802.11 standard) Chase, and α is information that is calculated from information concerning the A-MPDU maximum aggregation number. For example, α may be the same value as the A-MPDU maximum aggregation number, or may be a value that is obtained by multiplying the A-MPDU maximum aggregation number by a constant of proportionality.

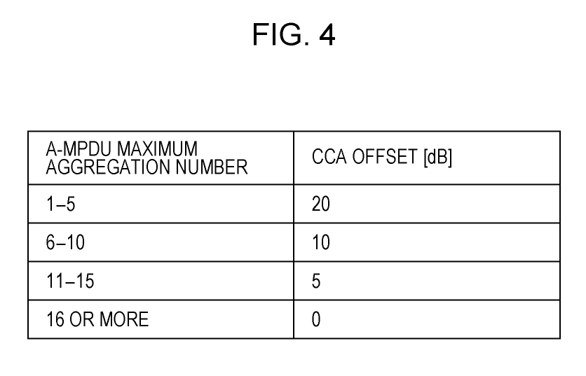

FIG. 4 illustrates an example of a table indicating a relationship between the A-MPDU maximum aggregation number and the CCA level. In the example of FIG. 4, a CCA offset s assigned to the value of the A-MPDU maximum aggregation number. Alternatively, the CCA level may be assigned to the value of the A-MPDU maximum aggregation number. The CCA offset and the CCA level may be expressed by a value in decibel or by a real value.

In this way, the terminal device 20 may modify the CCA level in accordance with the A-MPDU maximum aggregation number or may modify the A-MPDU maximum aggregation number or the A-MPDU number included in the transmission frame in accordance with the CCA level.

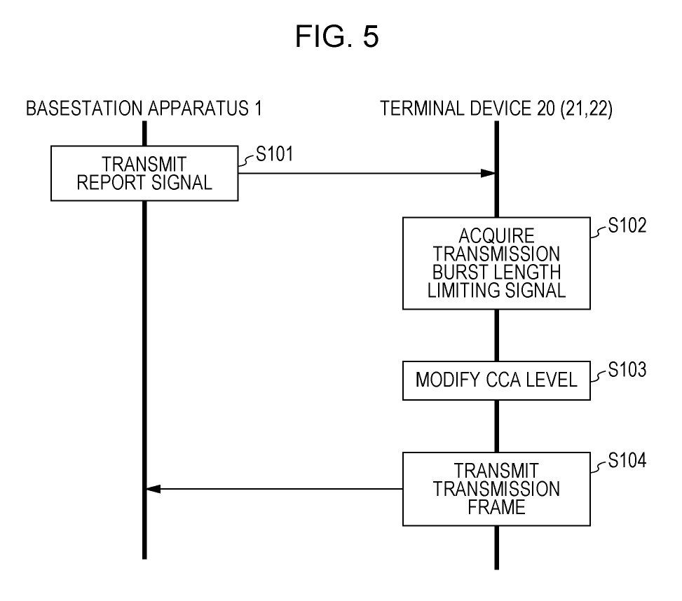

FIG. 5 is a sequence chart illustrating an example of a process performed by the base station apparatus 1 and terminal device 20. The base station apparatus 1 transmits a report signal (step S101). The report signal may be a management frame, a beacon, a PHY header or an MAC header in the transmission frame, Ack, a control frame or the like. In succession, the terminal device 20 receives the report signal transmitted from the base station apparatus 1, and acquires the transmission burst length limiting information (step S102). The terminal device 20 then modifies the CCA level (step S103). The order of operation steps S102 and S103 of the terminal device 20 may be reversed. In other words, the terminal device 20 may acquire information concerning the CCA level included in the report signal, and may configure the transmission burst length of the transmission frame, based on the information concerning the CCA level. The terminal device 20 starts transmitting the transmission frame after performing the carrier sense at the configured CCA level (step S104).

The terminal device 20 may modify the CCA level in response to the transmission burst length. More specifically, the terminal device 20 may modify the CCA level, based on the information concerning the transmission burst length of the transmission frame generated by the terminal device 20. For example, the terminal device 20 may configure the CCA level to be −72 dBm in the case that the terminal device 20 generates the transmission frame including an aggregate of three MPUDs, or the terminal device 20 may configure the CCA level to be −82 dBm in the case that the terminal device 20 generates the transmission frame including an aggregate of eight MPUDs. In this way, the terminal device 20 may modify the CCA level, based on the transmission burst length of the generated transmission frame.

The terminal device 20 may modify the transmission burst length in response to the configuration of the CCA level.

The terminal device 20 may also modify the configuration of the NAV in response to the configuration of the CCA level. More specifically, according an aspect of the present invention, the transmission burst length may include information concerning the NAV.

The terminal device 20 may modify the CCA level, based on functionality information of the transmission frame aggregation. For example, modifying the CCA level of a terminal device 20 having a transmission frame aggregation functionality may be inhibited, and modifying the CCA level of a terminal device 20 having no transmission frame aggregation functionality may be permitted. The base station apparatus 1 or terminal device 20 has a functionality to notify information as to whether to permit or inhibit the modification of the CCA level of the terminal device 20. The base station apparatus 1 or terminal device 20 has a functionality to transmit information as to whether to permit or inhibit the aggregation of the transmission frames.

One embodiment of the present invention may be implemented in a standard, other than IEEE802.11, for example, in Long Term Evolution (LTE) Standard.

The transmission burst length may be the sub frame number, system frame number, OFDM symbol number, partial subframe number, floating sub frame number, extended sub frame number, or the like.

### 2. Description Common to All Embodiments

A program running on the base station apparatus 1 and terminal device 20 according the embodiment of the present invention is a program controlling a CPU or the like (a program causing a computer to function) such that the functionalities of the embodiment of the present invention are implemented. Information to be handled by these devices may be temporarily stored on a RAM during processing, then stored on a variety of ROMs and HDDs, read by the CPU as necessary, and corrected and written. Recording media storing the program includes a semiconductor medium (such as ROM, or non-volatile memory card), an optical recording medium (such as DVD, MO, MD, CD, or BD), and a magnetic recording medium (such as a magnetic tape, or a flexible disk). The functionalities of the embodiment may be implemented by executing the loaded program. The functionalities of the embodiment of the present invention may also be implemented in cooperation with an operating system and other application programs in response to instructions of the program.

To circulate the program in the market, the program may be stored on a portable recording medium, or transferred to a server computer that is connected via a network, such as the Internet. In such a case, a storage device in the server computer falls within the embodiment of the present invention. Part or whole of the base station apparatus 1 and terminal device 20 of the embodiment may be implemented by LSI which is a typical integrated circuit. Each functional block of the base station apparatus 1 and terminal device 20 may be implemented in an individual chip. Alternatively, part or whole of the base station apparatus 1 and terminal device 20 of the embodiment may be integrated into a single chip. If each functional block is implemented as an integrated circuit, an integrated circuit controller is attached to the integrated circuit.

The technique of circuit integration may be implemented not only as LSI, but also as a dedicated circuit or a general-purpose processor. If a technique of circuit integration substitutable for LSI emerges as the semiconductor technology advances, an integrated circuit based on the technique may be used.

The present invention is not limited to the embodiment described above. The base station apparatus 1 and terminal device 20 of the present invention are not limited to the mobile device. The base station apparatus 1 and terminal device 20 may be used in stationary devices installed outdoors, or non-portable electronic devices. For example, the base station apparatus 1 and terminal device 20 may be used in an AV device, kitchen devices, cleaning and washing devices, air-conditioners, office equipment, vending machines, and other daily-life devices.

The embodiment of the present invention has been described with reference to the drawings. Specific configurations are not limited to the embodiment. Designs incorporated in the embodiment falls within the claims as long as the designs fall within the scope of the present invention.

### INDUSTRIAL APPLICABILITY

The present invention finds applications in the terminal device, the communication method, and the integrated circuit.

This application is based on and claims the benefit of priority of Japanese Patent Application No. 2015-161561, filed on Aug. 19, 2015, the entire contents of which are incorporated herein by reference.

### REFERENCE SIGNS LIST

1 Base station apparatus

3 Management area

20, 21, and 22 Terminal devices

11001 Higher layer unit

11002 Carrier sense unit

11003 Transmitter

11003a Physical layer frame generator

11003b Radio transmitting unit

11004 Receiver

11004a Radio receiving unit

11004b Signal demodulator

11005 Antenna unit

11006 Transmission burst length setting unit

1. A terminal device communicating with a base station device, comprising:
a transmitting unit that transmits a frame,
a transmission burst length setting unit that modifies a transmission burst length of the frame, and
a carrier sense unit that performs carrier sensing before the frame is transmitted,
wherein the transmission burst length of the frame is a first value when the carrier sensing with a first threshold is performed before the frame is transmitted and the transmission burst length of the frame is a second value when the carrier sensing with a second threshold is performed before the frame is transmitted.

2. The terminal device according to claim 1,
wherein the transmission bust length is related to a number of OFDM symbols.

3-7. (canceled)

8. A communication method of a terminal device, comprising:
a step of transmitting a frame,
a step of modifying a transmission burst length of the frame, and
a step of performing carrier sensing before the frame is transmitted,
wherein the transmission burst length of the frame is a first value when the carrier sensing with a first threshold is performed before the frame is transmitted and the transmission burst length of the frame is a second value when the carrier sensing with a second threshold is performed before the frame is transmitted.

9. An integrated circuit mounted on a terminal apparatus, comprising:
a transmitting circuit that transmits a frame,
a transmission burst length setting circuit that modifies a transmission burst length of the frame, and
a carrier sense circuit that performs carrier sensing before the frame is transmitted,
wherein the transmission burst length of the frame is a first value when the carrier sensing with a first threshold is performed before the frame is transmitted and the transmission burst length of the frame is a second value when the carrier sensing with a second threshold is performed before the frame is transmitted.
